(19) United States
(12) Patent Application Publication
(10) Pub. No.: US 2015/0176718 A1
(43) Pub. Date: Jun. 25, 2015

(54) Smart Valve and Related Control Method

(71) Applicant: Danchun Zhuo, Taizhou (CN)

(72) Inventor: Danchun Zhuo, Taizhou (CN)

(73) Assignee: WORLD ENVIRONMENTAL TECHNOLOGY JIANGSU CO., LTD, Suqian City (CN)

(21) Appl. No.: 14/580,042

(22) Filed: Dec. 22, 2014

(30) Foreign Application Priority Data
Dec. 23, 2013 (CN) 201310719954.3

(51) Int. Cl. F16K 31/04; F16K 31/05; F16K 37/00; F16K 3/00

(52) U.S. Cl. CPC F16K 31/046; F16K 3/00; F16K 31/05; F16K 37/0008; F16K 31/047

(57) ABSTRACT

A smart valve and the related control method to solve the problem of energy waste in current heating and air-conditioning systems due to the inconvenience of valve adjustment. The smart valve is constructed with the valve body, the valve stem, and the internal valve spool located inside the body of the valve. The specialty of the smart valve is its inclusion of controller, pressure differential transducer, display monitor and the keypad that can enter certain flow rate and operating information to the controller. The illustrated Actuator, pressure differential transducer, display monitor and the keypad are all connected with the controller. The controller is able to receive the parameter settings entered by the keypad and the pressure differential detected by the pressure differential transducer, and will process and send certain movement instructions to the actuator to drive the movements of the valve stem.

### BACKGROUND OF THE INVENTION

1. Related Applications

This application claims benefit of Chinese Patent Application No. CN201310719954.3, filed Dec. 23, 2013. The above application is incorporated by reference herein.

2. Field of Invention

The present invention relates to the field of valve technology, and particularly to a type of smart valve and the method of its control.

### RELATED ART

With urban development, buildings will surpass industrial, transportation and other businesses; and rank first in social energy consumption, amounting 30% to 40%; building related energy efficiency will be the focus of energy conservation effort. Large public buildings are characterized by high total energy consumption, high energy consumption per unit, high energy-savings potential which is easy to realize. Survey & research have shown that, for public buildings, a potential of 10% to 30% energy saving is readily available.

Among them, a building's heating and air conditioning system occupies a larger portion of its energy consumption, primarily for conducting heat transfer via water flow distribution. In the process of water flow distribution, the pipelines' valves are used to adjust flow rates for water delivery and to switch on or off.

However, the flaw of the current heating and air-conditioning systems is that, once installed, valves are barely adjusted, despite of changes of the season or heating needs. Valve adjustment requires trained maintenance staff with specific equipment, which are prone to inept flow adjustment, or, untimely adjustment causing energy waste or over energy consumption, and stiff adjustment procedures difficult to manage.

### SUMMARY OF THE INVENTION

One objective of this invention is to the existing drawbacks of the prior art stated above. Another object of the invention is to provide an easily adjustable smart valve and related control method capable of reducing the energy consumption of heating and air-conditioning systems.

The above objects of the present invention can be achieved by the following:

A smart valve is constructed with a valve body, a valve stem, and a valve spool located inside the valve body. The inner end of the valve stem is solidly connected to the valve spool, with its outer end protruding out of the valve body and connected with an actuator that drives its movements. The smart valve is characterized by its inclusion of a controller, a pressure differential transducer capable of sensing the pressure differential across the valve, a display monitor and a keypad that can transmit flow rate setting and valve operating setting data to the controller. The actuator, the pressure differential transducer, the display monitor and the keypad are all connected with the controller. Furthermore, the controller is able of receiving the parameter setting entered by the keypad and the pressure differential sensed by the pressure differential transducer, will process and send the resulting control signal to control the actuator to execute prescribed valve stem movements.

This smart valve, based on user's need, through the keypad and the display monitor provided on the smart valve, can receive direct input of required flow rate setting or valve opening setting, where the valve opening data, combined with pressure differential across the valve sensed by the pressure differential transducer and relevant valve parameters (for example, diameter, etc.), can be used to calculate valve flow rate using preset equations. The ease of adjustment enables the maintenance staff to timely adjust flow rate everywhere, according to users' needs and seasonal changes, reducing energy waste and energy inefficiency. This invention adopts the balanced valve spool for effortless operation, less water stream impact to the spool and, thereby, extended valve service life.

In the present smart valve, the smart valve also includes a thermostat that can transmit analog signal to the controller mentioned above. The keypad also includes a switching module that can switch the control methods of the controller. The thermostat is connected with the above mentioned controller. According to the control mode inputted from the switching module, the controller can utilize the switching module to selectively switch in analog control method (to control based on the analog signal input from the thermostat) or digital control method (to control based on the parameter setting input from the keypad), then control the valve opening based on the received parameter setting and the pressure differential sensed by the pressure differential transducer.

In the present smart valve, the smart valve also includes a communication unit connected to the controller that can conduct data communication with remote terminals. The RS-485 communication port installed on the controller enables the smart valve to have remote control and centralized control ability. The remote control system can adjust the valve opening and the flow rate through this communication port installation, similar to that of a keypad.

In the present smart valve, there is also a temperature sensor connected to the controller. The temperature sensor can detect the temperature of the liquid medium flowing through the valve body. The controller can determine whether the system is operating in the heating or in the cooling mode, based on the temperature data relayed by the temperature sensor, since the flow rate and adjustment requirements for heating and cooling are different.

In the present smart valve, the actuator also includes the driving motor, the motor driver that controls the driving motor and the transmission gear. The motor driver is connected to the controller. The output end of the driving motor is connected to the valve stem via the transmission gear.

In the present smart valve, the actuator also includes manual handwheel connected to the transmission gear. Besides using the motor to actuate the valve movements, valve opening can be adjusted through the manual handwheel.

In the present smart valve, the actuator is also provided a displacement sensor to detect the valve rod position. The displacement sensor is connected to the controller. The valve opening data detected by the displacement sensor enable the controller to perform closed-loop control, for more precise control and easier display.

In the present smart valve, the transmission gear is set leveled. The displacement sensor includes scroll wheel, which locates under the transmission gear and is in contact with the transmission gear. The transmission gear can drive the scroll wheel's rotation. The scroll wheel has angular displacement sensor attached that can detect the angular displacement of the scroll wheel. The transmission gear can mesh with the scroll wheel's skew teeth via its ground screw thread or skew teeth, thus drives the rotation of the scroll wheel. The transmission gear can also abut the scroll wheel and generate friction force to drive the rotation of the scroll wheel. The angular displacement sensor can detect the rotational displacement of the scroll wheel. Based on that data and the size of the scroll wheel, along with the dimensions of the transmission gear, the rotational status of the transmission gear can be calculated, which indirectly yields the displacement distance the valve stem was driven by the transmission gear. The displacement sensor is installed within the mounting box of the transmission gear, for easy installation and for reduction of external disturbance, which will improve sensor accuracy. Meanwhile, the adoption of small-diameter scroll wheel will further improve the sensing precision of the angular displacement sensor.

In the present smart valve, the output shaft of the driving motor is equipped with a worm drive that is circumferentially fixed and axially slidable. The worm drive meshes with the transmission gear. The top end of the worm drive is equipped with first spring that acts on the output shaft of the driving motor and the top end of the worm drive. The bottom end of the worm drive is equipped with second spring that acts on the output shaft of the driving motor and the bottom end of the worm drive. Both first spring and second spring clasp the output shaft of the driving motor. The worm drive is not stationary nor fixed, there are certain separation between first spring and second spring. Acted by the forces of first spring and second spring, the worm drive can mesh better with the transmission gear.

The best power transmission happens when the cog-teeth on the worm drive mesh well with the cog-teeth on the transmission gear.

In the present smart valve, also clasping onto the output shaft of the driving motor is the third spring. One end of the third spring extends inside of the second spring and acts on the bottom end of the worm drive. The other end of the third spring acts on the output shaft of the driving motor. The elastic coefficient of the third spring is smaller than that of the second spring. The third spring enables additional fine adjustment. By adjusting the compression length of the third spring, the elasticity of the second spring and its effect on the worm drive can be adjusted. Adaptive adjustments enable the worm drive and the transmission gear to have the best meshing condition.

In the present smart valve, the valve body is equipped with shell structure. The middle of the transmission gear is screwed connected with screw that goes along with the axial direction of the transmission gear. The end of the screw is equipped with stopper that locates within the shell structure. The stopper is connected with the valve stem and can drive the reciprocation of the valve stem. Both sides of the stopper are equipped with stopper groove. There are strip-shaped stopper plates located within the shell structure that match with the stopper groove. The stopper plates are equipped along the axial direction of the valve stem and are plugged in the stopper grooves. The transmission gear is installed with bearings. The driving motor drives the rotation of the transmission gear. The middle of the transmission gear is equipped with sleeves with internal screw thread. There are screw-connected screws within the sleeves. The rotation of the transmission gear can drive the screw to conduct up-and-down reciprocating movement. The screw can control the opening and closing of the valve by driving the movement of the valve stem. To enable the stabilization of the reciprocating movement of the valve stem driven by the screw, stopper plate is equipped on the valve body; stoppers are equipped between the screw and the valve stem. The stoppers can only make movements along the stopper plates. This setting ensures stabilized movement of the valve stem.

The control method of the smart valve, using the valve to adjust the flow rate of the liquid medium. The control method includes the following procedures:

a. Initialization: initialize the control parameter of the smart valve and the set up of the display.

b. Choosing control method: read the entered control method then determine the chosen control method; if the analog control method is chosen, then follow procedure c; if the digital control method is chosen, then follow procedure d.

c. Analog control method: collect information of the current valve opening and the input analog signal; convert the analog signal into corresponding signal of the valve opening. Compare the preset signal of the valve opening and the current valve opening of the smart valve then output corresponding control signal for smart valve to adjust the valve opening.

d. Digital control method: collect information of the current valve opening and the input digital signal; convert the digital signal into corresponding signal of the valve opening. Compare the preset signal of the valve opening and the current valve opening of the smart valve then output corresponding control signal for smart valve to adjust the valve opening.

In the control method of the smart valve, between procedure a. and procedure b., operator should read the valve parameter data first. Needed information for display and calculation include model number, diameter, etc.

In the control method of the smart valve, after obtaining the valve parameter data, collect information about the entered digital signal then display, and proceed to procedure b.

As another situation in the control method of the smart valve, is that, during procedure b, if digital signal control method is chosen, then collect the input digital signal and display first, and then proceeds to procedure d.

In the control method of the smart valve, the digital signal includes preset valve flow rate and/or preset valve opening value.

In the control method of the smart valve, the operator should first collect the preset valve opening, if that information is not attainable, then proceeds to collecting the preset valve flow value.

Another situation in the control method of the smart valve is to first collect the preset valve flow rate, if that information is not attainable, then proceed to collect the preset valve opening.

In the control method of the smart valve, during procedure c. and procedure d., after getting the preset valve opening signal, sample the temperature of the medium flowing through the valve, and determine if it is under heating or cooling mode. Based on the preset adjustment parameters for either heating or cooling, the preset valve opening signal can be adjusted. Since the flow rate requirements for cooling and heating modes are different, the pre-set parameters can be adjusted using associated parameters previously inputted into the controller or using a table.

Compared to current technology, the smart valve and the control method has the following advantages:

1. The smart valve and the control method can adjust the valve opening and, thus, the valve flow rate, using two control methods, either by inputting analog signal or by direct input of digital signal using a keypad. It is easier and versatile, enabling the management staff to timely adjust the flow rate of either the heating or the cooling systems thus reducing energy waste and lowering the energy consumption.

2. The smart valve and the control method can utilize the remote control terminal to centralize the control of multiple smart valve's flow rates, it is easier to manage and to adjust.

### BRIEF DESCRIPTION OF THE DRAWINGS

The present invention will become more fully understood from the detailed description given herein below for illustration only, and thus are not limitative of the present invention, and wherein:

FIG. 1 is a block diagram of one embodiment of the smart valve.

FIG. 2 is a flowchart of one control method of the smart valve.

FIG. 3 is a schematic view of one embodiment of the smart valve.

FIG. 4 is a schematic cross-sectional view of one embodiment of the smart valve.

FIG. 5 is an internal structure diagram of one embodiment of the smart valve.

FIG. 6 is a partial enlarged structure diagram of one embodiment of the smart valve.

FIG. 7 is an internal structure diagram of one embodiment of a controller of the smart valve.

### DETAILED DESCRIPTION OF THE INVENTION

The embodiments of the invention will be described below and the technical solutions of the invention will be further illustrated in connection with the accompanying figures. However, the present invention shall not be limited to these embodiments.

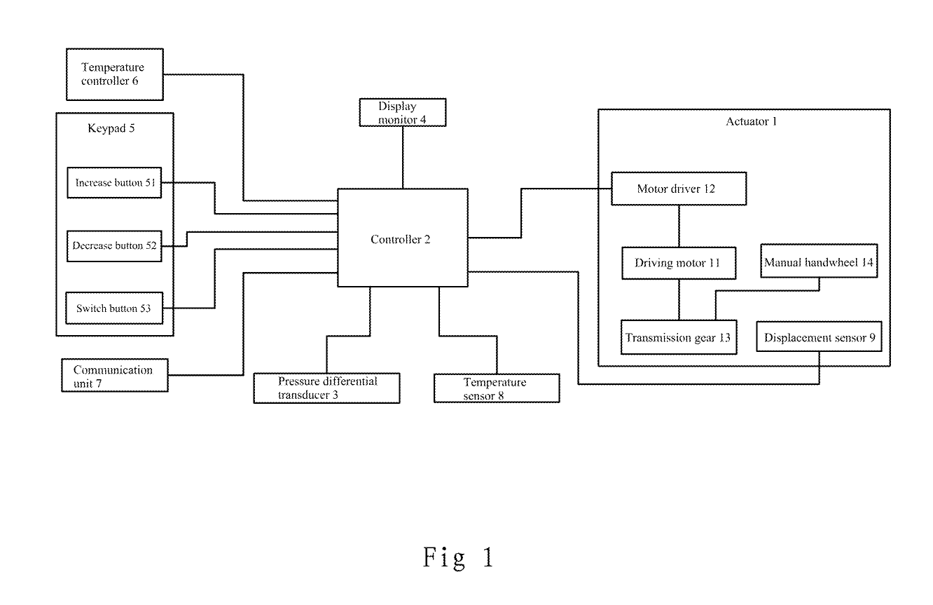

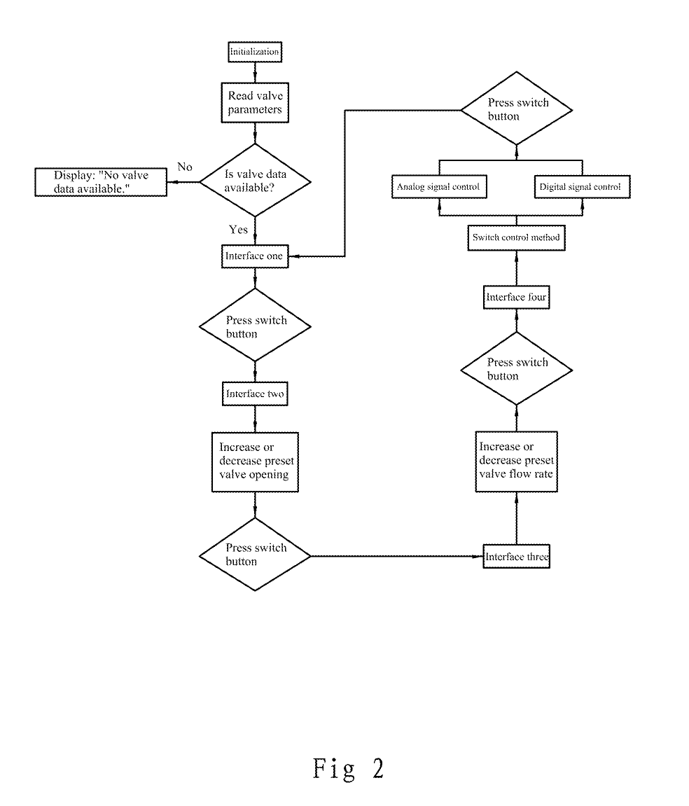

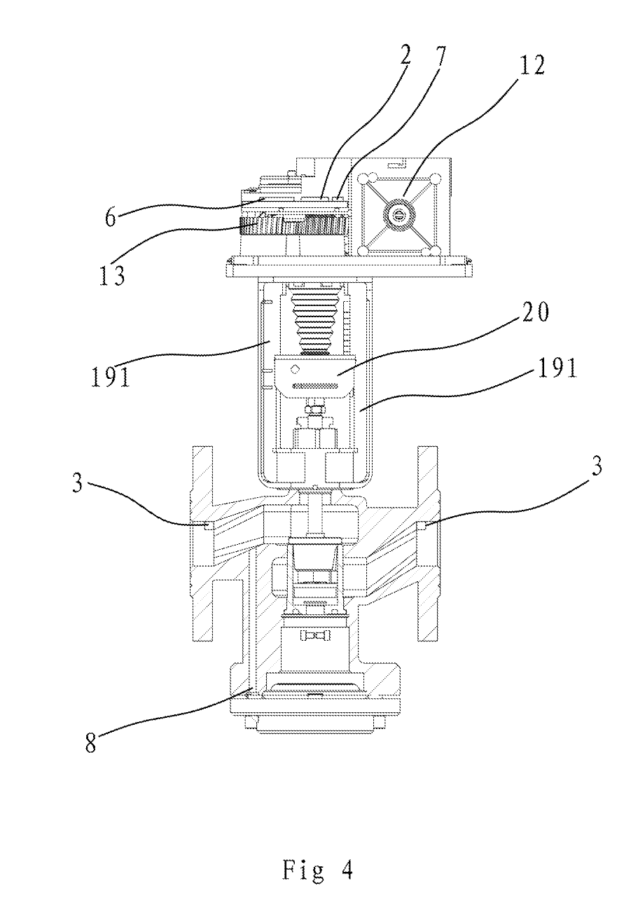

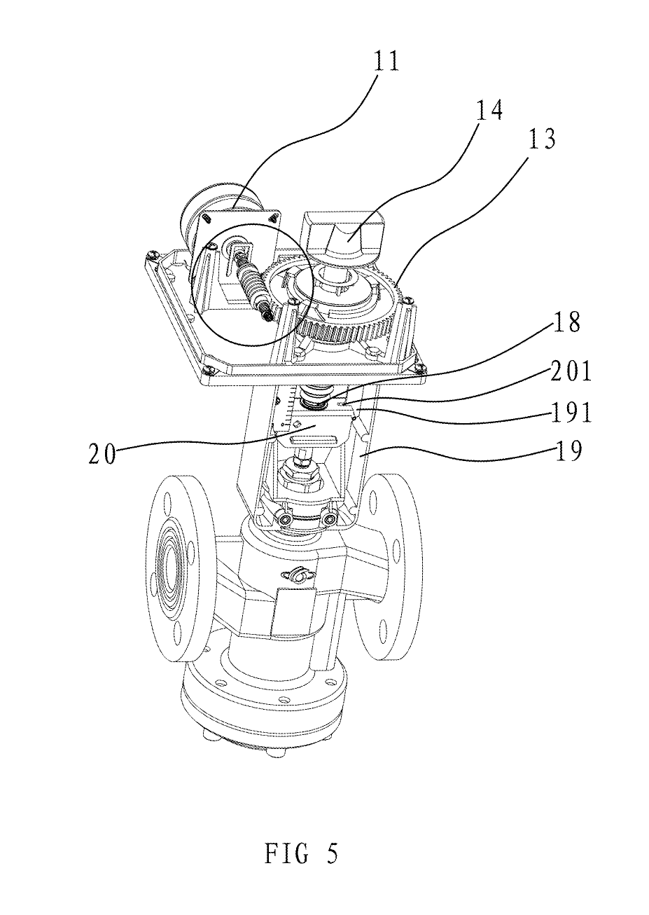

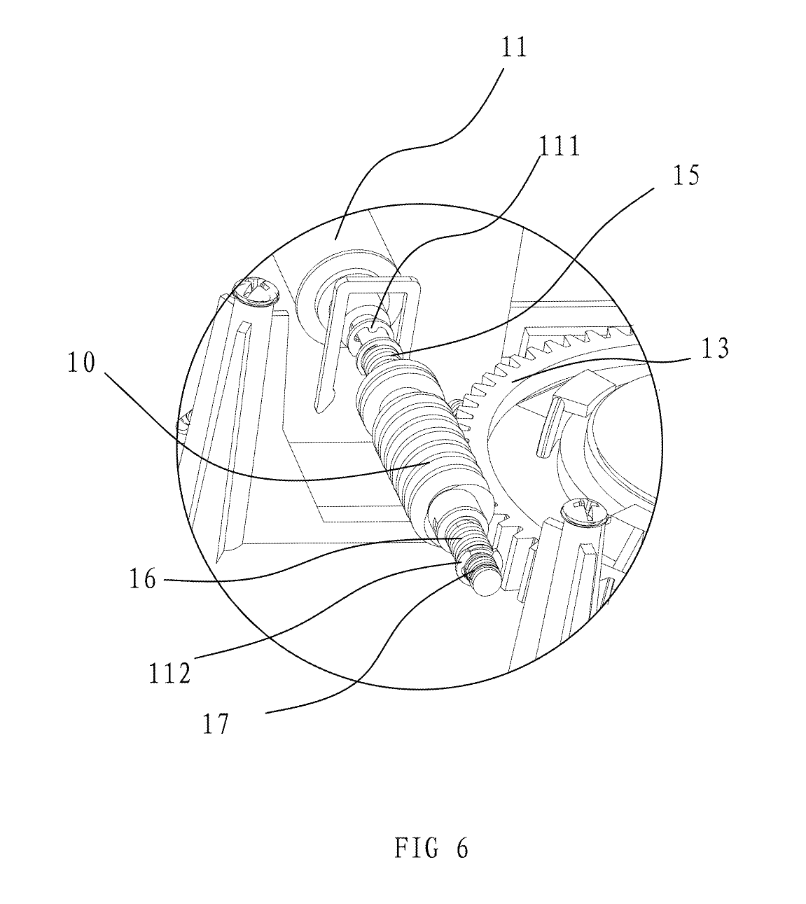

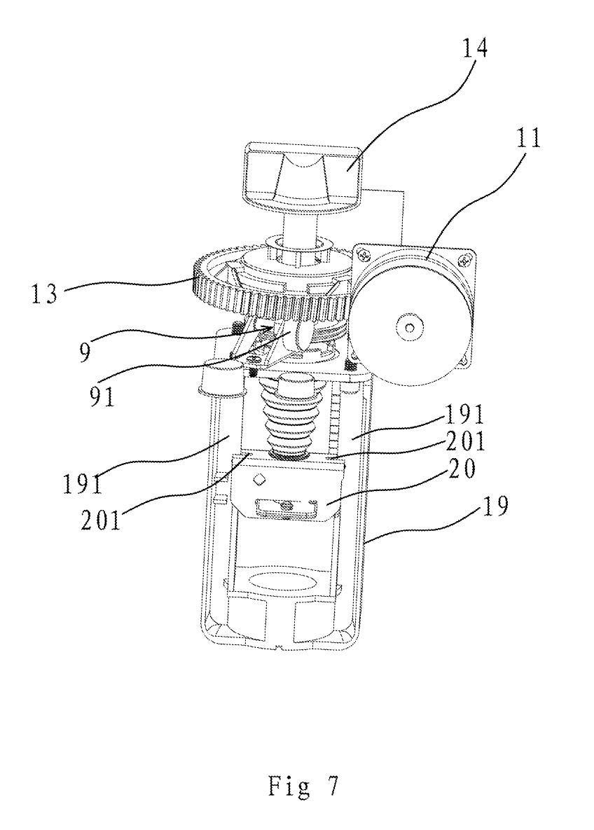

As shown in FIGS. 1 to 7, the smart valve includes the valve body, valve stem and the internal valve spool located inside the valve body. The inner end of the valve stem is connected to the valve spool; the outer end of the valve stem extends outside of the valve body and is connected with an actuator 1 that drives its movements. As shown in FIG. 1, the smart valve includes controller 2 and the pressure differential transducer 3 that can detect the pressure differential across the valve, display monitor 4, temperature sensor 8 that can detect the flowing liquid medium's temperature, temperature controller 6 that can transmit analog signal to the controller 2, the keypad 5 that can enter information about flow value and valve opening to the controller 2, and the communication unit 7 that can communicate with remote control terminal. All of the above are connected with the controller 2.

Specifically, keypad 5 includes increase button 51 that can increase the value of the flow rate or the valve opening, the decrease button 52 that can decrease the value of the flow rate or the valve opening, and the switch button 53 that can switch display interface. Actuator 1 includes manual handwheel 14, driving motor 11, motor driver 12 that can drive the movement of the driving motor 11 and transmission gear 13, motor driver 12 is connected to the controller 2, the output end of the driving motor 11 is connected to the valve stem via the transmission gear 13. The manual handwheel 14 is connected with the transmission gear 13.

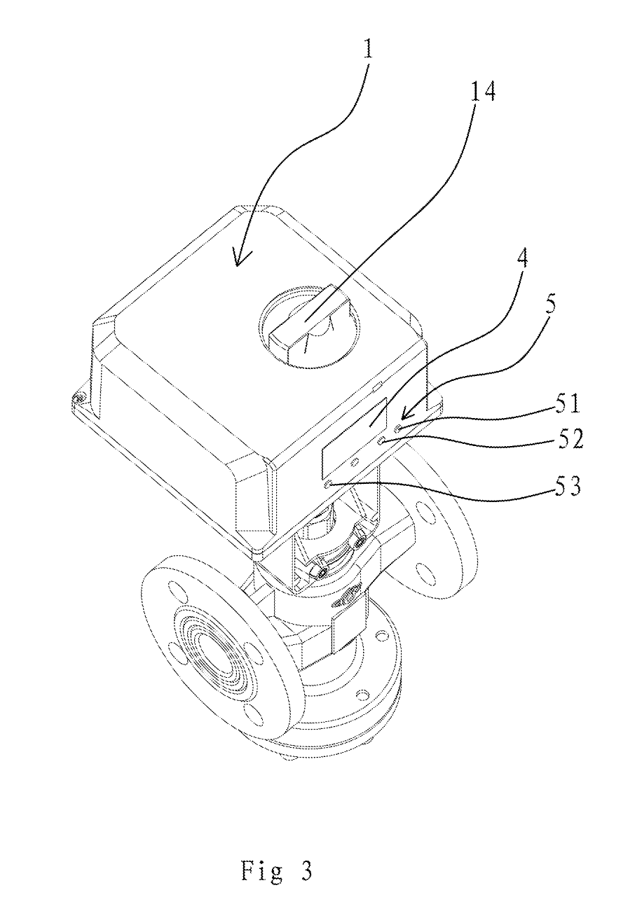

As shown in FIGS. 3 to 7, the transmission gear 13 is set leveled. The displacement sensor 9 includes scroll wheel 91, which locates under the transmission gear 13 and have contact with the transmission gear 13. The transmission gear 13 can enable the scroll wheel 91's rotation. The scroll wheel 91 has angular displacement sensor that can detect the angular displacement of the scroll wheel. Based on the detected data and the size of the scroll wheel 91 along with the size of the transmission gear 13, the rotation of the transmission gear 13 can be calculated. That leads to the calculation of the displaced distance of the valve stem driven by the transmission gear 13.

The output shaft 110 of the driving motor 11 is equipped with a worm drive 10 that is circumferentially fixed and axially slidable, the worm drive 10 is meshed with the transmission gear 13, the length of the output shaft 110 is longer than the length of the worm drive 10, the first spring 15 and the second spring 16 are both clasped on the output shaft 110 of the driving motor 11, the top end of the worm drive 10 is near the driving motor 11, and the two ends of the first spring 15 act respectively on the clip 111 fixed on the output shaft 110 of the driving motor 11 and the top end of the worm drive 10, the bottom end of the worm drive 10 is away from the driving motor 11, the two ends of the second spring 16 act on the clip 112 fixed on the output shaft 110 of the driving motor 11 and the bottom end of the worm drive 10. On the output shaft 110 of the driving motor 11 is also clasped the third spring 17, one end of the third spring 17 goes through the clip 112, extend inside the second spring 16 and act on the bottom end of the worm drive 10, the other end of the third spring 17 acts on the output shaft 110 of the driving motor 11, the elastic coefficient of the third spring 17 is less than the elastic coefficient of the second spring 16. The forces exerted by the first spring 15, second spring 16, and the third spring 17 cause a better mesh between the worm drive 10 and the transmission gear 13, with a positive engagement between the teeth of the worm drive 10 and the teeth of the transmission gear 13, yielding the best force transmission.

The valve body is equipped with shell structure 19, The middle of the transmission gear 13 is screwed connected with screw 18 that goes along the axial direction of the transmission gear 13. The end of the screw 18 is equipped with stopper 20 that locates within the shell structure 19. The stopper 20 is also connected with the valve stem and can drive the movement of the valve stem. Both sides of the stopper 20 are equipped with stopper groove 201. There are strip-shaped stopper plates 191 located within the shell structure 19 that match with the stopper groove 201. The stopper plate 191 is installed along the axial direction of the screw 18 and plugged in the stopper groove 201. The stopper plate 191 is installed within the shell structure 20. The stopper 20 can only make movements along the stopper plate 191. This setting enables the stabilization of the reciprocating movement of the valve stem. There is also indicator signs with scales equipped on the shell structure 19. There are indicating arrows on the stopper 20, by reading the shift length of the stopper 20 it can be indicated the shift length of the valve stem.

The bottom of the valve body has opening hole that connects the water canal. The temperature sensor 8 is located within the opening hole and this setting can stabilize the waterflow going through the opening hole, thus the detection is more precise. The two pressure differential transducers are located on both the inflow end and the outflow end of the canal. This setting can eliminate the effect of the spool on the water pressure thus the detection is more precise.

The controller 2 utilizes the ATmega88 of the AVR serial mono chip. Temperature controller 6 can choose other control system that can output analog signal. The pressure differential transducer 3 utilizes two pressure sensors, which located at the testing openings at both ends of the valve body. Communication unit 7 is the RS-485 communication interface installed on controller 2 so that the smart valve can have remote control and central control capacity. The remote control system can set the valve opening and flow value via the communication interface. This setting works like keypad 5. The invention adopts the balanced valve, which serves the purpose of saving effort, and avoiding the stream erosion, thus extends the service life of the valve. The actuator 1 has displacement sensor 9 that can detect the location of the valve stem. The displacement sensor 9 is connected with controller 2. Controller 2, keypad 5, display monitor 4, and actuator 1 are all located within the shell structure.

The width of the valve opening and the flow rate of the water stream can be set via the keypad and the display monitor based on the users' need. The degree of the width of the valve opening can be calculated using a preset equation based on the detected different pressure by the pressure differential transducer and the related parameter (for example, the diameter, etc.). The easy approach enables the maintenance staff to adjust the flow rate according to the user's need and the change of the seasons to reduce the energy consumption. The invention adopts the balanced valve, which serves the purpose of saving energy, and avoiding the stream erosion, thus extends the service life of the valve.

In order to make it easy to display and operate, the display on the display monitor 4 connected to the valve body is divided into four interfaces. The switch button 53 can be utilized to switch between the interfaces. The function of the increase button and decrease button in different interfaces is different as well: interface one (display of the name of the company, the mode number of the valve, etc.); interface two (display of the preset valve opening, the current valve opening, the current flow value and unit of the flow value); interface three (display of the preset flow value, the current flow value and the unit of the flow value); interface four (display of analog signal control or digital signal control options). The control method of the smart valve includes the following procedures:

a. Initialization: the initialization of the registers in the mono-chips. Displays the initial interface

a.1. Read the parameters of the valve (the model number of the valve, caliber and other parameters for display and calculation). If this information is not attainable, display ‘no valve data available’; if this information is attainable then display the initial display and proceed to the next procedure;

a.2. Push switch button 53, enter the next display interface and proceed to the next procedure;

a.3. Push increase button 51 or decrease button 52 to either increase or decrease the valve opening then put on display monitor 4.

a.4. Push switch button 53, save the preset valve opening then proceed to the third display;

a.5. Push increase button 51 or decrease button 52 to increase or decrease the preset flow value and display through display monitor 4

a.6. Push switch button 53, save the preset flow value then enter the fourth interface, where the operator can enter the valve opening and the flow value.

b. By pushing either increase button 51 or decrease button 52, either analog digital control or digital signal control is chosen. By pushing the switch button 53, the setting is saved. If chosen analog signal control, then proceed to procedure c; if chosen digital signal control, then proceed to procedure d. If analog signal control is preferred, the operator does not have to enter the preset flow value and preset valve opening before.

c. Analog control method: utilizing the displacement sensor 9 to collect information of the current valve opening and the entered analog signal; switch the analog signal into signal of the valve opening. Compare the preset signal of the valve opening and the current valve opening of the smart valve then export corresponding control signal for smart valve to adjust the valve opening to the motor driver 12, driving motor 11 drives the movement of the valve stem so that it can adjust the valve opening of the smart valve.

d. Digital signal control: utilizing the displacement sensor 9 to collect information of the current valve opening and the digital signal (valve opening or flow value) entered by keypad 5 or entered by the remote control terminal. Compare the preset signal of the valve opening and the current valve opening of the smart valve then export corresponding control signal for smart valve to adjust the valve opening to the motor driver 12, driving motor 11 drives the movement of the valve stem so that it can adjust the valve opening of the smart valve.

Other than the mentioned technical plan above, the second to fourth display can be adjusted according to different situations; related controlling procedure can be switched as well. Keypad 5 can be utilized to switch the control methods. In procedure c. and procedure d, after getting the switched valve opening signal, it can be compared with the preset parameter based on the temperature of the flowing liquid medium detected by the temperature sensor 8, then decide either it is heating or cooling mode. Then based on the preset parameters for heating or cooling, to adjust the valve-opening signal.

The description of the preferred embodiment serves only as an illustration of the invention, the inventors and technicians of this invention can make revision or supplementary changes to the invention within the defined rights in the attached patent claims.

### LIST OF REFERENCE NUMERALS

1 Actuator
2 Controller
3 Pressure differential Transducer
4 Display monitor
5 Keypad
6 Temperature Controller
7 Communication Unit
8 Temperature Sensor
9 Displacement Sensor
10 Worm drive
11 Driving Motor
12 Motor Driver
13 Transmission Gear
14 Manual Handwheel
15 First Spring
16 Second Spring
17 Third Spring
18 Screw
19 Shell Structure
20 Stopper
51 Increase Button
52 Decrease Button
53 Switch Button
91 Scroll Wheel
191 Stopper Plate
201 Stopper Groove

What is claimed is:

1. A smart valve comprising:
a valve body;
a valve stem;
an internal valve spool located inside the valve body;
an inner end of the valve stem connected to the valve spool;
an outer end of the valve stem extends outside of the valve body and is connected with an actuator (1) that drives its movements;
a controller (2);
a pressure differential transducer (3);
a display monitor (4); and
a keypad (5) that can enter certain flow rates and operating information into the controller (2);
wherein the actuator (1), the pressure differential transducer (3), the display monitor (4), and the keypad (5) are all connected with the controller (2), the controller (2) capable of receiving setup parameters entered by the keypad (5) and a pressure differential sensed by the pressure differential transducer (3), and will process and then send certain movement orders to the actuator (1) to drive the actions of the valve stem.

2. The smart valve as claimed in claim 1, further comprising:
a temperature controller (6) capable of transmitting analog signals to the controller (2), the temperature controller (6) is connected to the controller (2);
wherein the keypad (5) includes a switching module capable of switching control methods of the controller (2).

3. The smart valve as claimed in claim 1, further comprising:
a communication unit (7) connected to the controller (2), the communication unit (7) capable of conducting data communications with a remote terminal.

4. The smart valve as claimed in claim 1, further comprising:
a temperature sensor (8) connected to the controller (2), the temperature sensor capable of detecting a temperature of liquid medium flowing through the valve body.

5. The smart valve as claimed in claim 1, further comprising:
a driving motor (11) connected to the actuator (1), the driving motor (11) having an output interface;
a motor driver (12) that controls the driving motor (11), the motor driver (12) being connected to the controller (2); and
a transmission gear (13);
wherein the output interface of the driving motor (11) is connected to the valve stem via the transmission gear (13).

6. The smart valve as claimed in claim 5, further comprising:
a manual handwheel (14) connected to the actuator (1) via the transmission gear (13).

7. The smart valve as claimed in claim 4, further comprising:
a displacement sensor (9) attached to the controller (2) located at the actuator (1) capable of detecting a position of the valve stem.

8. The smart valve as claimed in claim 7, wherein the transmission gear (13) is leveled;
wherein the displacement sensor (9) includes a scroll wheel (91), the scroll wheel (91) being located under the transmission gear (13) and having contact with the transmission gear (13);
wherein the transmission gear (13) is capable of enabling rotation of the scroll wheel (91); and
wherein the scroll wheel (91) has an angular displacement sensor attached that is capable of detecting angular displacement of the scroll wheel (91).

9. The smart valve as claimed in claim 5, further comprising:
an output shaft of the driving motor (11), the output shaft equipped with a worm drive (10) that is circumferentially fixed and axially slidable, the worm drive (10) meshes with the transmission gear (13);
a top end of the worm drive (10) equipped with a first spring (15) that acts on the output shaft of the driving motor (11) and the top end of the worm drive (10); and
a bottom end of the worm drive (10) equipped with a second spring (16) that acts on the output shaft of the driving motor (11) and the bottom end of the worm drive (10);
wherein both the first spring (15) and the second spring (16) clasp on the output shaft of the driving motor (11).

10. The smart valve as claimed in claim 9, wherein the output shaft of the driving motor (11) is also clasped with a third spring (17);
wherein one end of the third spring (17) extends inside of the second spring (16) and acts on the bottom end of worm drive (10);
wherein an other end of the third spring (17) acts on the output shaft of the driving motor (11); and
wherein an elastic coefficient of the third spring (17) is smaller than that of the second spring (16).

11. The smart valve as claimed in claim 9, wherein the valve body is equipped with a shell structure (19);
a middle of the transmission gear (13) is screwed connected with a screw (18) that goes along an axial direction of the transmission gear (13), an end of the screw (18) is equipped with a stopper (20) located within the shell structure (19), the stopper (20) connected to the valve stem and is capable of driving reciprocation of the valve stem;
wherein both sides of the stopper (20) are equipped with a stopper groove (201); and
wherein strip-shaped stopper plates (191) are located within the shell structure (19) that match with the stopper groove (201).

12. A control method of a smart valve utilizing the smart valve to adjust a flow rate of liquid medium, the control method comprising the following steps:
a. initializing a control parameter of the smart valve and setting up a display;
b. reading an entered control method, deciding a chosen control method, and then proceeding to step c if the chosen control method is analog or proceeding to step d if the chosen control method is digital;
c. collecting information of a current valve opening and an entered analog signal, switching the analog signal into a valve opening signal, comparing a preset signal of a valve opening and the current valve opening of the smart valve, and then exporting a corresponding control signal for the smart valve to adjust the valve opening; and
d. collecting information of the current valve opening and an entered digital signal, switching the digital signal into the valve opening signal, comparing the preset signal of the valve opening and the current valve opening of the smart valve, and then exporting the corresponding control signal for the smart valve to adjust the valve opening.

13. The control method of smart valve as claimed in claim 12, wherein between step a and step b, a preset parameter data is read first.

14. The control method of smart valve as claimed in claim 13, wherein after reading the preset parameter data of the valve, information about the entered digital signal is collected and then displayed, before proceeding to step b.

15. The control method of smart valve as claimed in claim 13, wherein during step b, if a digital signal control method is chosen, the entered digital signal is collected first and then displayed, before proceeding to step d.

16. The control method of smart valve as claimed in claim 14, wherein the digital signal includes a preset flow value and/or a preset valve opening information.

17. The control method of smart valve as claimed in claim 15, wherein the digital signal includes a preset flow value and/or a preset valve opening information.

18. The control method of smart valve as claimed in claim 16, wherein an operator first collects the preset valve opening information or, if that information is not attainable, then proceeding to collect the preset flow value.

19. The control method of smart valve as claimed in claim 17, wherein an operator first collects the preset valve opening information or, if that information is not attainable, then proceeding to collect the preset flow value.

20. The control method of smart valve as claimed in claim 14, wherein an operator first collects the preset valve opening information or, if that information is not attainable, then proceeding to collect the preset flow value.
